(19) United States
(12) Patent Application Publication
(10) Pub. No.: US 2025/0222726 A1
(43) Pub. Date: Jul. 10, 2025

(54) OPTICAL CAMERA BASED AND MACHINE LEARNING TRAINED FLAT TIRE DETECTION

(71) Applicant: Torc Robotics, Inc., Blacksburg, VA (US)

(72) Inventor: Walter Grigg, Blacksburg, VA (US)

(21) Appl. No.: 18/409,617

(22) Filed: Jan. 10, 2024

(51) Int. Cl. B60C 23/06

(52) U.S. Cl. CPC B60C 23/06

(57) ABSTRACT

A vehicle, system, and method includes a camera configured to capture a plurality of images of a tire and a memory storing instructions, as well as one or more processors configured to access the memory and execute the instructions to receive a first tire image of the plurality of images, receive a second tire image of the plurality of images, wherein the second tire image is captured subsequent to the first tire image, compare the first and second tire images, determine a change in a shape of the tire from the comparison of the first and second tire images, and determine a type of tire-related irregularity based at least in part on the change in the shape of the tire.

### TECHNICAL FIELD

The field of the disclosure relates generally to autonomous vehicles, and more particularly, to a system and associated method of monitoring tires while driving in an autonomous vehicle or semi-autonomous vehicle.

### BACKGROUND

Tractor trailer operation and maintenance pose many different mechanical challenges, which include dealing with tire failures and other issues. Tire failures can result in dangerous and costly situations. In one example, the tread of one tire may wear down more quickly than on others. In other examples, one or more tires may be underinflated or exhibit signs of tread or belt separation. Even when a vehicle operator regularly services the tractor trailer and pays attention to developing situations, some tire conditions remain difficult to detect or predict. The inspection and detection of tire defects may be further complicated with autonomous vehicles, where there is no experienced driver to sense or monitor for potential tire irregularities.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle includes a least one computer-readable storage medium with instructions stored thereon that, in response to execution by at least one processor, cause the at least one processor to receive a first tire image of the plurality of images, receive a second tire image of the plurality of images, wherein the second tire image is captured subsequent to the first tire image, compare the first and second tire images, determine a change in a shape of the tire from the comparison of the first and second tire images, and determine a type of tire-related irregularity based at least in part on the change in the shape of the tire.

In another aspect, a method of identifying a type of tire-related irregularity includes receiving a first tire image of the plurality of images, receiving a second tire image of the plurality of images, where the second tire image is captured subsequent to the first tire image, comparing the first and second tire images; determining a change in a shape of the tire from the comparison of the first and second tire images; and determining a type of tire-related irregularity based at least in part on the change in the shape of the tire.

In another aspect, at least computer-readable storage medium with instructions stored thereon may, in response to execution by at least one processor, cause the at least one processor to receive a first tire image of the plurality of images, receive a second tire image of the plurality of images, where the second tire image is captured subsequent to the first tire image, compare the first and second tire images, determine a change in a shape of the tire from the comparison of the first and second tire images, and determine a type of tire-related irregularity based at least in part on the change in the shape of the tire. Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 illustrates a vehicle which may include a truck that may further be conventionally connected to a single or tandem trailer to transport the trailers to a desired location.

FIG. 2 is an exemplary schematic block diagram of a computing device for an illustrative automated tire monitoring and defect detection system.

FIG. 3 is a block diagram of an autonomous driving system, including an autonomous vehicle that is communicatively coupled with a mission control computing system.

FIG. 4 is a block diagram showing illustrative components of an optical tire monitoring and assessment system juxtaposed with an outline of an autonomous or semi-autonomous vehicle.

FIG. 5 illustrates side views of tires experiencing different fire failures that may be identified and reported by an embodiment of the system.

FIG. 6 shows frontal views of tires that possess varying levels of tire compression that may be monitored and identified by an embodiment of the system of the present disclosure.

FIG. 7 shows partial frontal views of three tires at various states of inflation as may be monitored and identified by processes of an implementation.

FIG. 8 is a flow diagram illustrating an embodiment of a method of performing tire monitoring and assessment for an autonomous driving tractor trailer rig.\

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

An implementation of the system may leverage existing cameras and sensors positioned toward the rear of an autonomous tractor to sense present and developing problems with trailer tire operation based on visually tracked changes and other inputs. In a sense, optical sensors (i.e., cameras) may provide an enhanced perspective of visual cues conventionally gleaned from human driver's point of view (e.g., looking into rear facing mirrors). Other sensors likewise may provide additional inputs analogous to a driver sensing irregular vibrations and sounds in a tractor cab. Such sensor data, like tire pressure monitoring system (TPMS) inputs, may be retrieved and analyzed in conjunction with visual, quantifiable data pertaining to a changing shape of one or more tires. Other illustrative inputs from a rear facing sensor suite may include thermal sensors, radar, and light detection and ranging (LIDAR), among others.

From an optics perspective, the system may detect and continuously track changes in the shapes of the tires during the duration of a trip. Such changes may be discerned from video or still camera oriented to enable the camera or video to collect data along the entire length of the trailer. In one example, a tire may exhibit progressive bulging as a trip progresses. In another instance, a tire may oscillate due to retreads coming apart. The present state of the tire may be compared against an earlier image of the same tire to quantify any visual change. For instance, an image of a tire at the onset of a trip may be used as a control image against which continuously collected images of the tire are compared. Alternatively, after the trip has started the ‘baseline’ tire image may be updated from the image of the tire at the start of the trip to an image of the tire recorded during the trip. The updated baseline image is then compared/contrasted with later collected images of the tire to determine if there is a visual change in tire shape. The rate of change of a deformation or other altering of the tire shape or configuration may additionally be monitored and uploaded for analysis. A detected change may be input to a decision-making algorithm of the autonomous driving system (ADS), along with other the sensor data, such as decreasing pressure readings from a TPMS.

Machine learning processes may include models trained with historical databases of tire images under different conditions. The models may be trained to automatically characterize an existing state of the tire or tire surroundings based on sensed conditions, such as real-time images of tires. In one example, a blowout of an inner tire may cause its sister, or tandem tire, to take on a greater load. As such, the tandem tire may exhibit different compression characteristics than before the loss of the inner tire. Relatedly, a tire failure may affect the compression of other combinations of tires, allowing the autonomous driving system to glean additional information regarding the status of all tires for assessing road worthiness.

In an implementation, the machine learning models may be used to determine (or recommend to a human) whether a change in the visual appearance of the tire is likely to pose an impediment to continued travel. In another example, a model may recognize that a visual change is likely a newspaper or cardboard that has been caught up and whipping around a tire. While the system may determine that such an occurrence does not pose a challenge to continued travel, the visual identification of flying debris around the tire may suggest a potential catastrophic tire blowout. In this manner, the models may be trained with millions of frames of video to categorize different types of tire failures (e.g., deformations, aging effect, deflections, cracks in the sidewall, worn tread, sidewall failure, underinflation, air pockets, overloading, foreign materials, improper mounting, retread failure, and tread separation, etc.), as well as external forces potentially affecting tire performance.

Certain predetermined types of identified tire events may be designated for reporting to a mission control center. For example, the onboard system of an embodiment may upload video and other sensor data for a human at the mission control center to assess a potential problematic situation. Recorded video, imagery, and other sensor data of the event may eventually be uploaded as inputs to the model. Feedback to the training model may include post-event evaluations by a mechanic confirming the tire condition.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

A smart vehicle: A smart vehicle is a vehicle installed with on-board computing devices, one or more sensors, one or more controllers, and/or one or more internet-of-things (IoT) devices which enables the vehicle to receive and/or transmit data to another vehicle and/or a server.

Mission control: Mission control, also referenced herein as a centralized or regionalized control, is a hub in communication with one or more autonomous vehicles of a fleet. Human agents, or artificial intelligence based agents, positioned at mission control may monitor data or service requests received from the autonomous vehicle and may dispatch a rescue vehicle (also referenced herein as a service vehicle) at the autonomous vehicle's location.

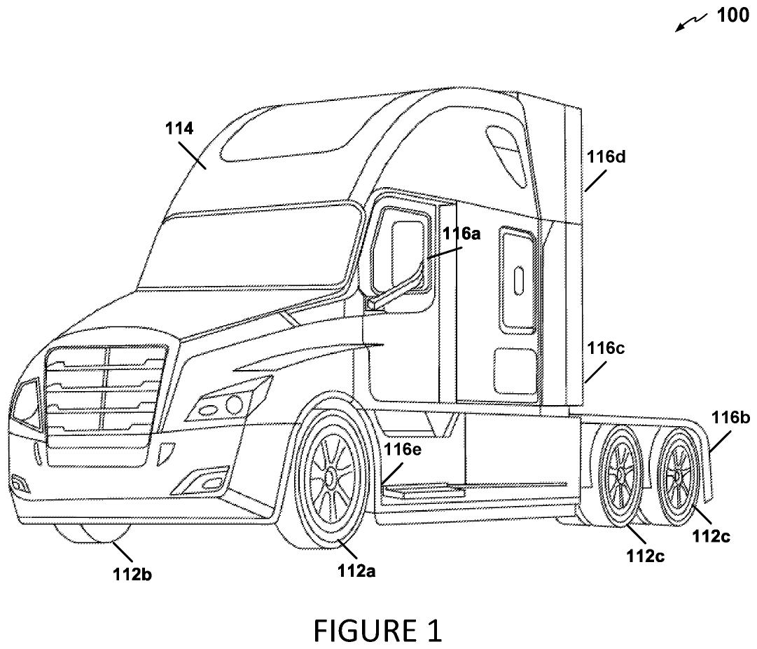

FIG. 1 illustrates a vehicle 100 which may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel and the steering column may be omitted in an autonomous vehicle. Sensors 116a-e may sense present and developing problems with trailer tire operation based on visually tracked changes and other inputs. Optical sensors may be rear facing to image the trailer tires, but the orientation and positioning of the sensors 116a-e in FIG. 1 is arbitrary and it should be understood they may be positioned at any suitable location internal or external to the vehicle 100.

The vehicle 100 may detect and continuously track changes in the shapes of the tires during the duration of a trip. Such changes may be discerned from the cameras that are oriented down the length of the trailer. Illustrative sensors 116a-e may include any sensor capable of indicating a change in a shape, pressure, temperature, and movement of a tire or of an area proximate the tire. For example, the vehicle 100 may include cameras, IR sensors, vibration sensors, acoustic sensors, TPMS inputs (e.g., from trailer tires), and accelerometer, among others.

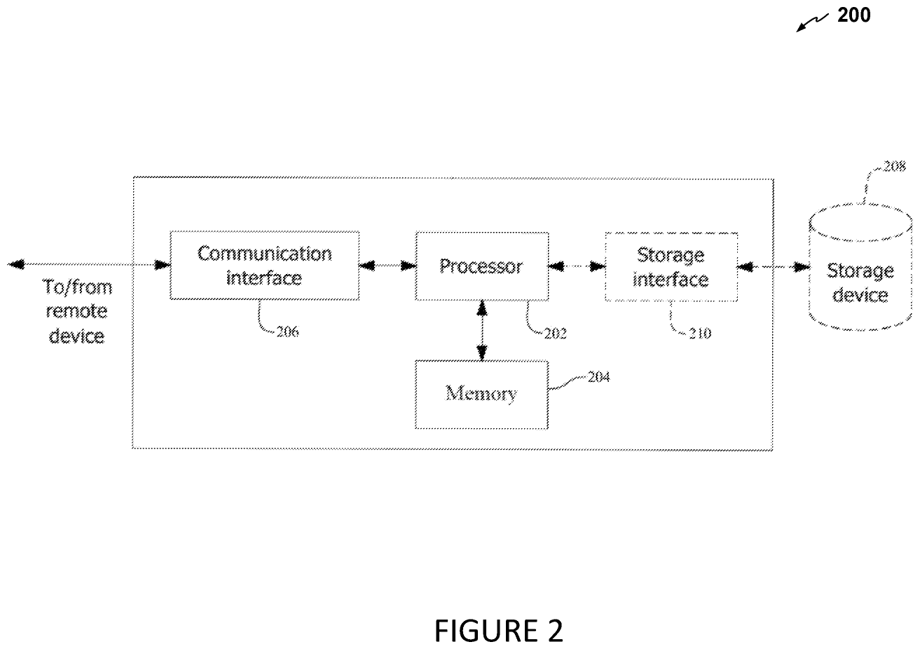

FIG. 2 is an exemplary schematic block diagram of a computing device 200 for implementation of embodiments of the present disclosure. The computing device 200 may include the automated tire monitoring and defect detection system described herein. The computing device 200 may include one or more processing units or processors 202 (e.g., in a multi-core configuration). Processor 202 may be operatively coupled to a communication interface 206 such that the computing device 200 is capable of communicating with another device, such as a remote application server, a user equipment, a mobile device, a smart vehicle, a mission control or a central hub, or another computing device, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the computing device 200. For example, the computing device 200 may include one or more hard disk drives as storage device 208.

In other embodiments, storage device 208 may be external to the computing device 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

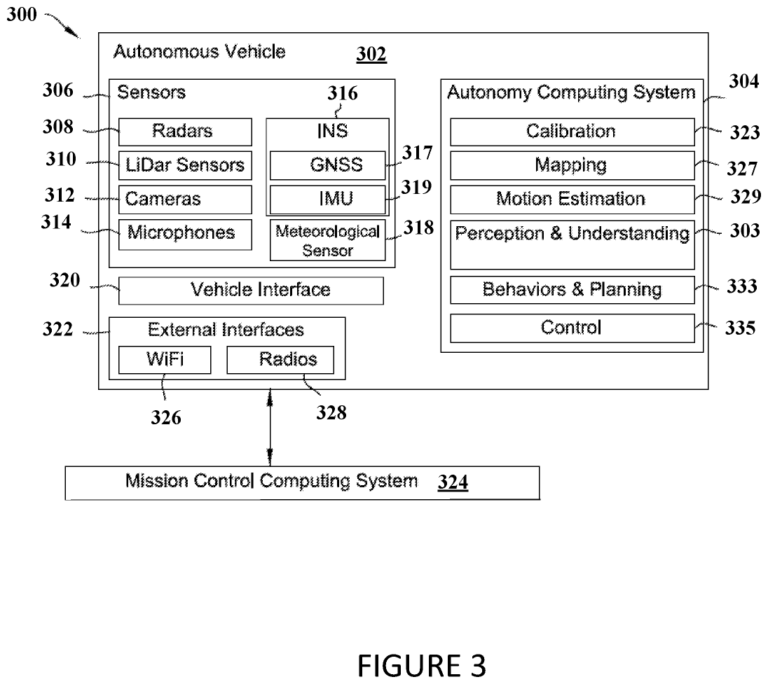

FIG. 3 is a block diagram of an autonomous driving system 300, including an autonomous vehicle 302 that is communicatively coupled with a mission control computing system 324. The vehicle 302 may be similar or the same as described with reference to any of the preceding figures.

In some embodiments, the mission control computing system 324 may transmit control commands or data to the autonomous vehicle 100, navigation commands, and travel trajectories to the autonomous vehicle 100, and may receive telematics data from the autonomous vehicle 302.

In some embodiments, the autonomous vehicle 100 may further include sensors 306. Sensors 306 may include radio detection and ranging (RADAR) devices 308, light detection and ranging (LiDAR) sensors 310, cameras 312, and acoustic sensors 314. The sensors 306 may further include an inertial navigation system (INS) 316 configured to determine states such as the location, orientation, and velocity of the autonomous vehicle 100. The INS 316 may include at least one global navigation satellite system (GNSS) receiver 317 configured to provide positioning, navigation, and timing using satellites. The INS 316 may also include an inertial measurement unit (IMU) 319 configured to measure motion properties such as the angular velocity, linear acceleration, or orientation of the autonomous vehicle 100. The sensors 306 may further include meteorological sensors 318. Meteorological sensors 318 may include a temperature sensor, a humidity sensor, an anemometer, pitot tubes, a barometer, a precipitation sensor, or a combination thereof. The meteorological sensors 318 are used to acquire meteorological data, such as the humidity, atmospheric pressure, wind, or precipitation, of the ambient environment of autonomous vehicle 302.

The autonomous vehicle 302 may further include a vehicle interface 320, which interfaces with an engine control unit (ECU) (not shown) or a MCU (not shown) of the autonomous vehicle 302 to control the operation of the autonomous vehicle 302 such as acceleration and steering.

The autonomous vehicle 302 may further include external interfaces 322 configured to communicate with external devices or systems such as another vehicle or mission control computing system 324. The external interfaces 322 may include Wi-Fi 326, other radios 328 such as Bluetooth, or other suitable wired or wireless transceivers such as cellular communication devices. Data detected by the sensors 306 may be transmitted to mission control computing system 324 via any of the external interfaces 322.

The autonomous vehicle 302 may further include an autonomy computing system 304. The autonomy computing system 304 may control driving of the autonomous vehicle 100 through the vehicle interface 320. The autonomy computing system 304 may operate the autonomous vehicle 302 to drive the autonomous vehicle from one location to another.

In some embodiments, the autonomy computing system 304 may include modules 323 for performing various functions. Modules 323 may include a calibration module 325, a mapping module 327, a motion estimation module 329, perception and understanding module 303, behaviors and planning module 333, and a control module 335. Modules 323 and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 302.

In some embodiments, based on the data collected from the sensors 306, the autonomy computing system 304 and, more specifically, perception and understanding module 303 senses the environment surrounding the autonomous vehicle 302 by gathering and interpreting sensor data. A perception and understanding module 303 interprets the sensed environment by identifying and classifying objects or groups of objects in the environment. For example, perception and understanding module 303 in combination with various sensors 306 (e.g., LiDAR, camera, radar, etc.) of the autonomous vehicle 100 may identify one or more objects (e.g., pedestrians, vehicles, debris, etc.) and features of a roadway (e.g., lane lines) around autonomous vehicle 302, and classify the objects in the road distinctly.

In some embodiments, a method of controlling an autonomous vehicle, such as autonomous vehicle 302, includes collecting perception data representing a perceived environment of autonomous vehicle 302 using the perception and understanding module 303, comparing the perception data collected with digital map data, and modifying operation of the vehicle 302 based on an amount of difference between the perception data and the digital map data. Perception data may include sensor data from sensors 306, such as cameras 312, LiDAR sensors 310, RADAR 308, or from other components such as motion estimation 329 and mapping 327.

The mapping module 327 receives perception data or raw sensor data that can be compared to one or more digital maps stored in mapping module 327 to determine where the autonomous vehicle 302 is in the world or where autonomous vehicle 302 is on the digital map(s). In particular, the mapping module 327 may receive perception data from perception and understanding module 303 or from the various sensors sensing the environment surrounding autonomous vehicle 302 and may correlate features of the sensed environment with details (e.g., digital representations of the features of the sensed environment) on the one or more digital maps. The digital map may have various levels of detail and can be, for example, a raster map, or a vector map. The digital maps may be stored locally on the autonomous vehicle 302 or stored and accessed remotely. In at least one embodiment, the autonomous vehicle 302 deploys with sufficient stored information in one or more digital map files to complete a mission without connection to an external network during the mission.

The behaviors and planning module 333 and the control module 335 plan and implement one or more behavior-based trajectories to operate the autonomous vehicle 302 similarly to a human driver-based operation. The behaviors and planning module 333 and control module 335 use inputs from the perception and understanding module 303 or mapping module 327 and motion estimation 329 to generate trajectories or other planned behaviors. For example, behavior and planning module 333 may generate potential trajectories or actions and select one or more of the trajectories to follow or enact by the controller 335 as the vehicle travels along the road. The trajectories may be generated based on proper (i.e., legal, customary, and safe) interaction with other static and dynamic objects in the environment. Behaviors and planning module 333 may generate local objectives (e.g., following rules or restrictions) such as, for example, lane changes, stopping at stop signs, etc. Additionally, behavior and planning module 333 may be communicatively coupled to, include, or otherwise interact with motion planners, which may generate paths or actions to achieve local objectives. Local objectives may include, for example, reaching a goal location while avoiding obstacle collisions.

Based on the data collected from the sensors 306, the autonomy computing system 304 is configured to perform calibration, analysis, and planning, and control the operation and performance of autonomous vehicle 302. For example, the autonomy computing system 304 is configured to estimate the motion of autonomous vehicle 302, calibrate parameters of the sensors, such as the extrinsic rotations of cameras, LIDAR, RADAR, and IMU, as well as intrinsic parameters, such as lens distortions, in real-time, and provide a map of surroundings of autonomous vehicle 302 or the travel routes of autonomous vehicle 302. The autonomy computing system 304 is configured to analyze the behaviors of autonomous vehicle 302 and generate and adjust the trajectory plans for the autonomous vehicle 302 based on the behaviors computed by the behaviors and planning module 333.

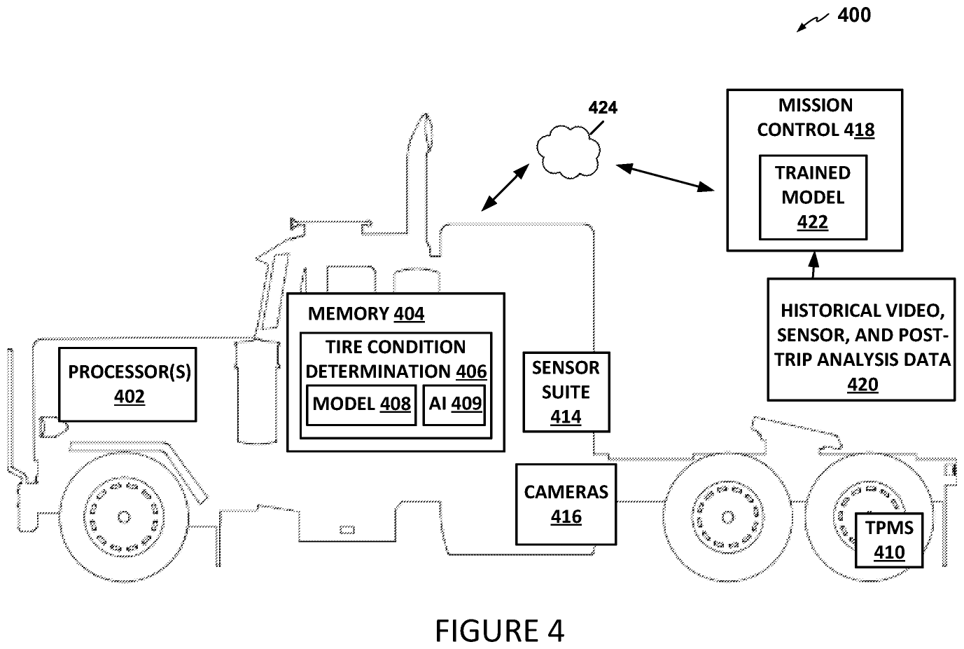

FIG. 4 is a block diagram showing illustrative components of an optical tire monitoring and assessment system 400 juxtaposed with an outline of an autonomous or semi-autonomous vehicle. The relative positioning of the modules with respect to the outline are not intended to indicate a physical location, as the underlying hardware, software, and functionality of the modules may be dispersed throughout the vehicle and remotely throughout the system 400. For example, the system 400 includes one or more processors 402 in communication with a memory 404. While the processors 402 and memory 404 are depicted as being included within the autonomous truck, the processors and memory of another implementation, as well as their related functions may be distributed throughout one or more local and remote systems. For instance, a mission control center 418 may communicate instructions and data via a wireless connection 424.

A memory 404 includes instructions (i.e., modules, or algorithms) executable by the processor 402 to monitor, assess and report tire conditions. For instance, a tire condition determination module 406 may receive inputs from cameras 416. The cameras 416 may be numbered and positioned to provide views of the tires. Imagery provided from the cameras may include video and still images. A sensor suite 414 may provide additional data used to ascertain a condition of a tire or of external forces affecting the tire. For instance, the sensor suite 414 may receive data communicating weights, pressures, and information about surrounding road conditions and traffic. Many of the sensors may be present on the vehicle for performing navigation and other driving related functions. Many such sensors may be rearward facing, while others may be located within the cab or distributed elsewhere on the vehicle. TPMS sensors, such as TPMS sensor 410. It is understood that TPMS and other sensors. Illustrative such sensors may include an infrared sensor, an acoustic detector, an accelerometer, a scale, a vibration sensor, a LiDAR sensor, and RADAR, among others.

As described herein, such data may be communicated to the processors 402, and in some implementations, the mission control center 418. Archived camera and sensor inputs, along with confirmed tire assessments 420 may be used to train a machine learning model 422 to assist in future tire assessments. For instance, the model 422 may be trained with data to identify and catalogue if a change in the shape of a tire, along with a drop in tire pressure, is consistently associated with a tire deflection that is later catalogued. Predictions and assessments made by models may be later verified and recorded. The verification and recording may be made by a mechanic where the model has made predictions and assessments based on actual road data. Where the model is additionally or alternatively populated with test facility data, the confirmation may be recorded by a lab technician. In this manner, tire shape changes may be used to identify different potential tire defects in addition to external forces acting upon the tire. A similar such model 408 may be present on the vehicle, itself, to make assessments without using a connection to a remote server. In some embodiments, local artificial intelligence (AI) 409 of the tire condition determination module 406 may perform initial modeling or other assessments, such as whether to escalate a tire status determination to the mission control center 418.

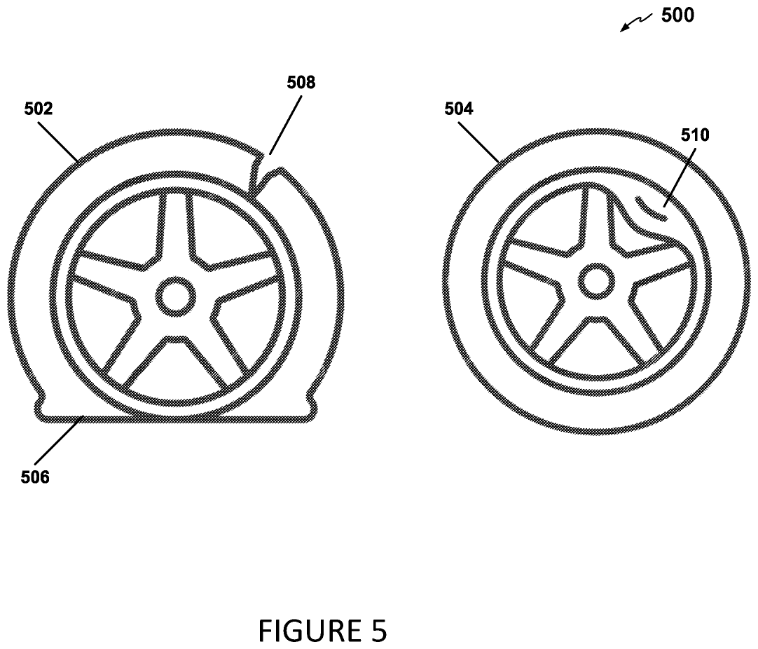

FIG. 5 illustrates side views of tires 502, 504 experiencing different fire failures that may be identified and reported by an embodiment of the system. The first tire 502 includes a flattened surface 506 caused by a fissure 508 in the tire surface. The damage to the tire 502 may be categorized as being a catastrophic failure. The second tire 504 depicts a bulge 510 in its sidewall. In one example, the system may monitor the bulge 510 as a trip progresses to predict the performance and viability of the tire 504.

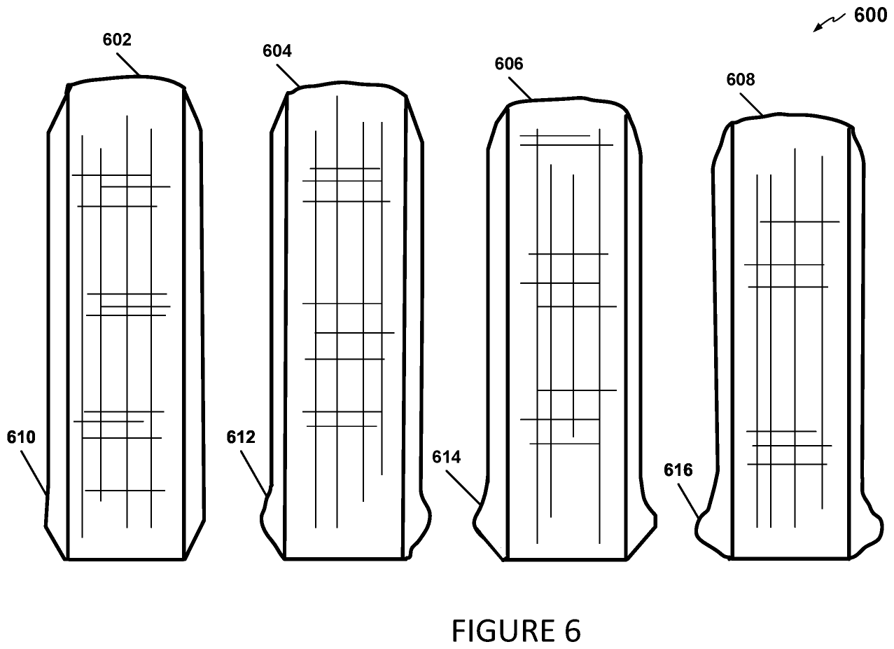

FIG. 6 shows frontal views of tires experiencing varying, progressive stages of tire compression. As described herein, an embodiment of the system may derive information about the tire and others on the trailer by the level of detected compression. More particularly, tire 602 exhibits a normal amount of compression expected under normal load conditions. The profile of the tire 602 may be similar to what might be expected to be imaged by a camera at the onset of a trip. The image may be a control image against which images of the tire are compared as the trip progresses. For example, the profile of the tire 604 exhibits a bulge 612 that is not present on the tire 602. The bulge 612 may be the result of increased compression attributable to an increased load on the tire 604. The increased load may be experienced as a result of damage to another tire on the trailer, such as an adjacent trailer. The bulge may also be the result of increased compression due to reduced tire inflation resulting in greater tire compression. Similarly, the tire 606 shows the effects of still greater compression. In tire 606, the diameter of the tire decreases as the lateral bulge dimension increases as shown in bulge 614 of tire 606. Finally, the tire 608 exhibits the greatest impact of an increasing load. Under the increased load, tire 608 has a decreased diameter/vertical distance from the road and the largest bulge 616 at the portion of the tire 608 in contact with the road. In operation, the system regularly collects data and images of the shape of the shape/contour of the profile of the tire proximate the portion of the tire in contact with the road. The shape/contour of the bulge associated with the portion of the tire in contact with the road is compared/contrasted with the stored historical data and images to determine if the tire bulge has changed shape.

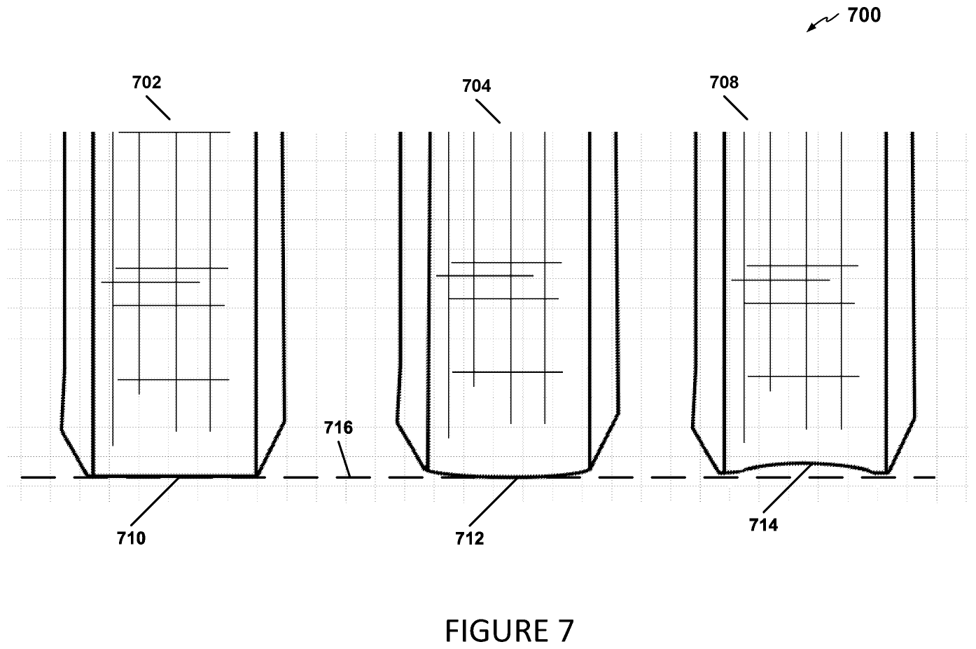

FIG. 7 shows partial frontal views of three tires 702, 704, 706 at various states of inflation. The different states of inflation may be monitored and identified by processes of an implementation. The first tire 702 is correctly inflated and has a surface 710 that is generally flush with the road 716. The second tire 704 is overinflated and thus has a convex curvature along the road surface 716. The third tire 706 exhibits a concave surface 714 indicative of an underinflated tire. As described herein, an embodiment of the system may assess whether a tire is properly inflated based on monitored, real-time imagery. In one implementation, the analysis may include comparing the tire characteristics to images of the same tire at different times during a trip. In another or the same implementation, the assessment may be made by comparing the shape of the tire to historical data comprising shapes of other tires. The historical data may be input into a model for the purpose of identifying different states of tire inflation. The collected historical data would identify the shape/contour of the portion of the tire in contact with the road and compare/contrast the images to determine if the tire is properly inflated.

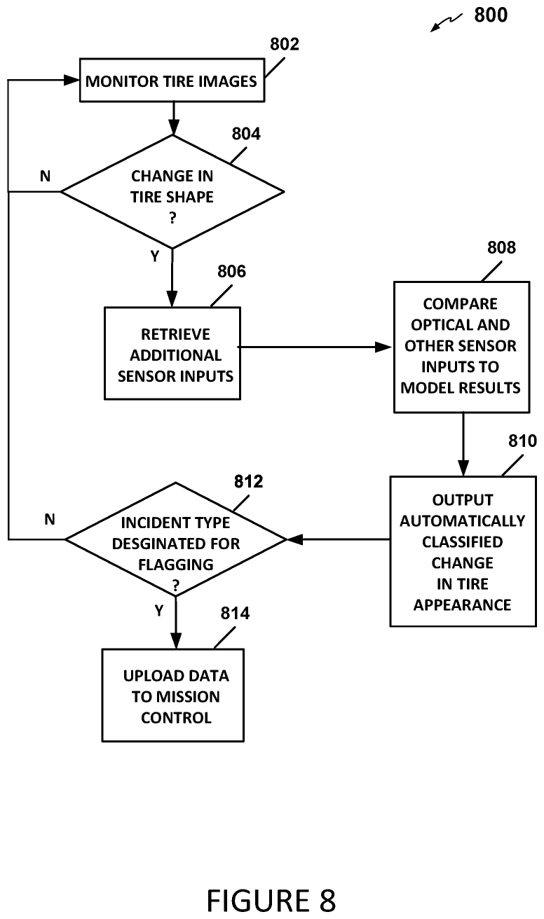

FIG. 8 is a flow diagram illustrating an embodiment of a method 800 of performing tire monitoring and assessment for an autonomous driving tractor trailer rig. While many of the illustrative processes described herein may apply to a semi-truck and trailer, the embodiments of the underlying method may apply to other types of autonomously driving vehicles. Moreover, the processes described in the flow diagram may be performed in different sequences in different embodiments of the method, which may omit or add other processes from that which is shown in the example of FIG. 8. The method 800 may be performed by any of the systems described in the preceding figures.

Turning more particularly to the flow diagram, the method 800 may monitor tires on a trailer at 802. For instance, the camera 416 of FIG. 4 may photograph an image of a trailer tire at the onset of a trip. This first image may function in some embodiments as a sort of control image against which subsequent images of the tire may be compared.

To that end, the method 800 may continuously monitor additional tire images as the trip changes towards potentially detecting at 804 a change in shape. For instance, the method 800 may detect a progressively flattening tire. That is, the method 800 may detect a slow leak in air pressure, which may be corroborated by additional sensor inputs at 806, such as by a TPMS. Other detected changes in shape may related to external forces affecting tire operation, rather than a failure in the structure of the tire, itself. For instance, a discarded paper bag or other litter may become caught up in the rotation of the tire.

A detected difference in the shape at 804 may cause the method 800 at 808 to compare the change in shape to be analyzed using a trained model. As described herein, the model may be trained using recorded images and inputs comprising the confirmed identification of different failures and performance related circumstances. Such images may be generated and recorded in a controlled testing environment or may be accumulated from real world travel footage from fleets of trucks over time.

An output of the model may be generated at 810. The output may include the method 800 automatically classifying the change in tire appearance. For example, the method 800 may determine that a catastrophic tire blowout on a rearmost driver side trailer tire has occurred. In another instance, the method 800 may determine that debris flying away from another tire is not indicative of damage to the tire.

In some instances, the method 800 may include determining that the type of incident indicated by the change of shape should be sent to the mission control center for further analysis by a human technician. Continuing with the above examples, a littered paper sack should not warrant intervention by mission control, but the tire blowout may be the type of tire failure designated for flagging mission control and uploading imagery and other sensor data at 814.

The client device as described herein may include a user equipment, a mobile device, a tablet, a smartwatch, a laptop, a smart glass, an internet-of-things (IoT) device, or a smart vehicle. The vehicle may be an autonomous vehicle, a semi-autonomous vehicle, or a non-autonomous vehicle.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A vehicle comprising:
a camera configured to capture a plurality of images of a tire;
a memory storing instructions;
one or more processors configured to access the memory and execute the instructions to:
receive a first tire image of the plurality of images;
receive a second tire image of the plurality of images, wherein the second tire image is captured subsequent to the first tire image;
compare the first and second tire images;
determine a change in a shape of the tire from the comparison of the first and second tire images; and
determine a type of tire-related irregularity based at least in part on the change in the shape of the tire.

2. The vehicle of claim 1, wherein determining the type of tire-related irregularity further comprises inputting the change in the shape into a model configured to classify the tire condition.

3. The vehicle of claim 2, wherein the one or more processors are further configured to train the model with recorded images of a plurality of types of tire-related irregularities that includes the type of tire-related irregularity.

4. The vehicle of claim 1, wherein the one or more processors are further configured to determine the type of tire-related irregularity based on additional sensor input.

5. The vehicle of claim 1, wherein the one or more processors are further configured to determine the type of tire-related irregularity based on sensor input form a tire-pressure monitoring system (TPMS).

6. The vehicle of claim 1, wherein the vehicle is at least one of an autonomous or semi-autonomous vehicle.

7. The vehicle of claim 1, wherein the one or more processors are further configured to determine whether the type of tire-related irregularity is one of a plurality of types of tire-irregularities to communicate to a mission control center.

8. The vehicle of claim 7, wherein the one or more processors are further configured to upload the first and second tire images to a mission control center.

9. The vehicle of claim 1, wherein the one or more processors are further configured to upload the first and second tire images to a mission control center.

10. The vehicle of claim 1, wherein the one or more processors are further configured to determine a rate of the change in a shape of the tire.

11. A method of identifying a type of tire-related irregularity, the method comprising:
receiving a first tire image of a plurality of images;
receiving a second tire image of the plurality of images, wherein the second tire image is captured subsequent to the first tire image;
comparing the first and second tire images;
determining a change in a shape of the tire from the comparison of the first and second tire images; and
determining a type of tire-related irregularity based at least in part on the change in the shape of the tire.

12. The method of claim 11, wherein determining the type of tire-related irregularity further comprises inputting the change in the shape into a model configured to classify the tire condition.

13. The method of claim 12, further comprising training the model with recorded images of a plurality of types of tire-related irregularities that includes the type of tire-related irregularity.

14. The method of claim 11, further comprising determining the type of tire-related irregularity based on additional sensor input.

15. The method of claim 11, further comprising determining whether the type of tire-irregularity is one of a plurality of types of tire-related irregularities to communicate to a mission control center.

16. The method of claim 11, further comprising uploading the first and second tire images to a mission control center.

17. At least one computer-readable storage medium with instructions stored thereon that, in response to execution by at least one processor, cause the at least one processor to:
receive a first tire image of a plurality of images;
receive a second tire image of the plurality of images, wherein the second tire image is captured subsequent to the first tire image;
compare the first and second tire images;
determine a change in a shape of the tire from the comparison of the first and second tire images; and
determine a type of tire-related irregularity based at least in part on the change in the shape of the tire.

18. The at least one computer-readable storage medium of claim 17, wherein determining the type of tire-related irregularity further comprises inputting the change in the shape into a model configured to classify the tire condition.

19. The at least one computer-readable storage medium of claim 18, wherein the at least one processor trains the model with recorded images of a plurality of types of tire-related irregularities that includes the type of tire-related irregularity.

20. The at least one computer-readable storage medium of claim 18, wherein the at least one processor determines whether the type of tire-related irregularity is one of a plurality of types of tire-irregularities to communicate to a mission control center.
